(19) United States
(12) Patent Application Publication
(10) Pub. No.: US 2005/0227680 A1
(43) Pub. Date: Oct. 13, 2005

(54) MOBILE PHONE AUTO-DIAL MECHANISM FOR CONFERENCE CALLS

(75) Inventor: Peter Snowden, Raleigh, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/709,077

(22) Filed: Apr. 12, 2004

(51) Int. Cl. H04M 3/42

(52) U.S. Cl. 455/416

(57) ABSTRACT

A system and method of automatic initiation for connecting a mobile phone to a conference call is disclosed. A mobile phone containing a software application for maintaining a schedule is coupled with another software application that reviews calendar event data stored in the mobile phone. Calendar event data can include a sub-category of event data relating to conference calls. Conference call event data includes a starting time, a telephone number, and a passcode authorizing connection to the conference call. The mobile phone automatically produces an alert shortly before the starting time of the conference call and displays a prompt asking whether to connect to the conference call. For an affirmative response, the mobile phone automatically dials the telephone number for the conference call. The mobile phone then receives a prompt for the passcode authorizing connection to the conference call. The mobile phone obtains the passcode from the conference call event data and automatically enters the passcode.

### BACKGROUND OF INVENTION

Mobile phone users increasingly rely on their mobile phones for their communication and organization needs. Most mobile phones today include scheduling, contact, and organizational software like that in personal digital assistants (PDAs). In addition, the mobile phone can retrieve schedule and contact data from another computer in a ‘syncing’ procedure that is commonplace. Thus, the phone can manage a user's schedule as well as provide a means for communication.

One of the events that can be part of a user's schedule is a conference call. Typically, a user can only participate in a conference call if they dial a designated number and input a designated passcode. The telephone number is usually a 10 digit number while the pass code can also add another four to seven digits. The conference call telephone number and passcode are typically stored along with the conference call event data so that the user can dial the number and enter the passcode if he wishes. Manually entering this information, however, is tedious at best and can be dangerously distracting if the user is performing another function like driving a vehicle.

What is needed is a means for automatically dialing and connecting to a scheduled conference call without having to key in the information manually.

### SUMMARY OF INVENTION

A system and method of automatic initiation for connecting a mobile phone to a conference call is disclosed. A mobile phone containing a software application for maintaining a schedule linked with data relating to scheduled calendar events is coupled with another software application that reviews calendar event data stored in the mobile phone. The calendar event data can include a sub-category of event data relating to conference calls. Conference call event data includes a starting time for the conference call, a telephone number for the conference call, and a passcode authorizing connection to the conference call. The mobile phone automatically produces an alert shortly before the starting time of the conference call and displays a prompt asking whether to connect to the conference call. For an affirmative response, the mobile phone automatically dials the telephone number for the conference call. The mobile phone then receives a prompt for the passcode authorizing connection to the conference call. The mobile phone obtains the passcode from the conference call event data and automatically enters the passcode.

The user can respond to the prompt by depressing the appropriate key on the keypad or can speak a designated keyword (e.g., ‘yes’) in a voice activated mode. This allows the user to connect to the conference call in a hands-free manner.

### BRIEF DESCRIPTION OF DRAWINGS

FIG. 1 illustrates a user's view for one of the screen shots on a mobile phone display relating to the present invention.

FIG. 2 illustrates a user's view for another of the screen shots on a mobile phone display relating to the present invention.

FIG. 3 illustrates a user's view for yet another of the screen shots on a mobile phone display relating to the present invention.

FIG. 4 is a flowchart detailing one embodiment for carrying out of the present invention.

### DETAILED DESCRIPTION

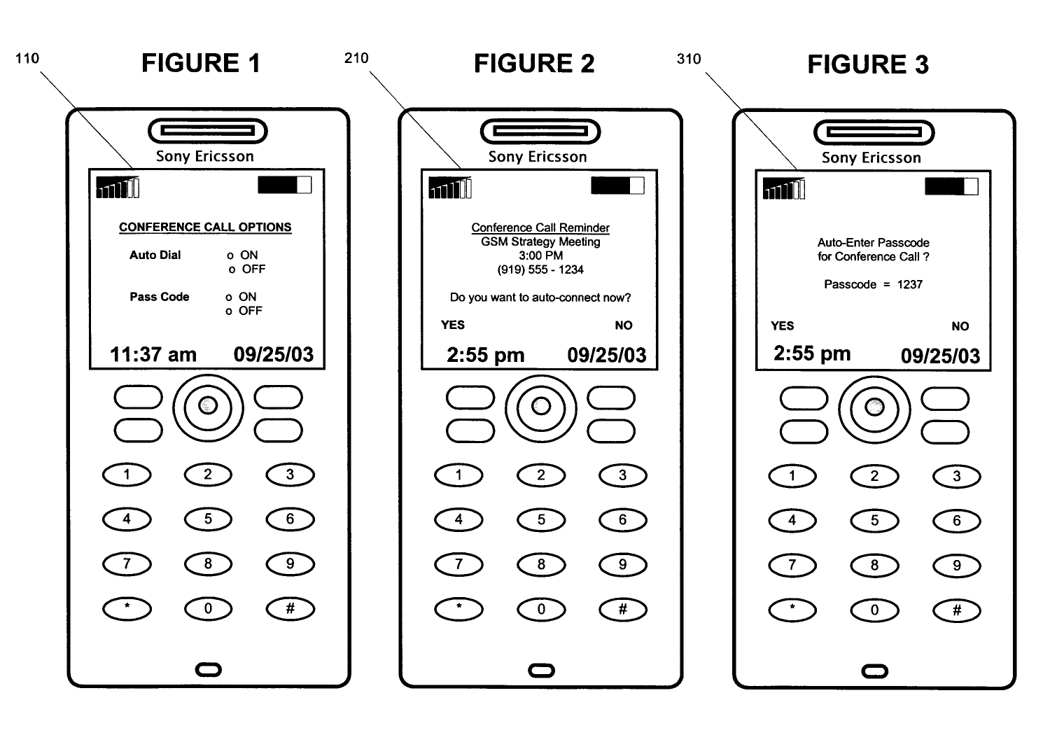

FIGS. 1 3 illustrate screen shots a user may encounter when the present invention is running on the mobile phone. FIG. 1 illustrates a settings screen 110 that allows the user to program the mobile phone to automatically dial and connect to conference call events detected in the schedule. A first pair of button boxes allow the user to toggle an auto-dial function on and off while a second pair of button boxes allow the user to toggle a passcode entry function on and off. If both button boxes are set “on” the conference call function is fully engaged.

FIG. 2 illustrates a reminder screen for a conference call event. This screen 210 will typically pop-up just before the scheduled conference call and prompt the user whether he wishes to connect to the designated phone number. Rather than dialing the number himself, the user need only press a single button corresponding to an affirmative response and the mobile phone will automatically dial the designated number. Alternatively, the prompt can be voice activated such that an audible “YES” from the user will cause the mobile phone to auto-dial the designated number. This is especially useful when the user is otherwise engaged with his hands.

Once the mobile phone dials and connects to the designated number, the mobile phone will receive back a prompt for a passcode. The passcode is the final hurdle that authorizes the user to participate in the conference call. The mobile phone, in turn, prompts the user as shown in FIG. 3 if he wishes to auto-enter the passcode 310. Just as before, the user can either press a single button to confirm or speak an affirmative “YES” in a voice activated mode. Either of these actions will then cause the mobile phone to enter the requested passcode.

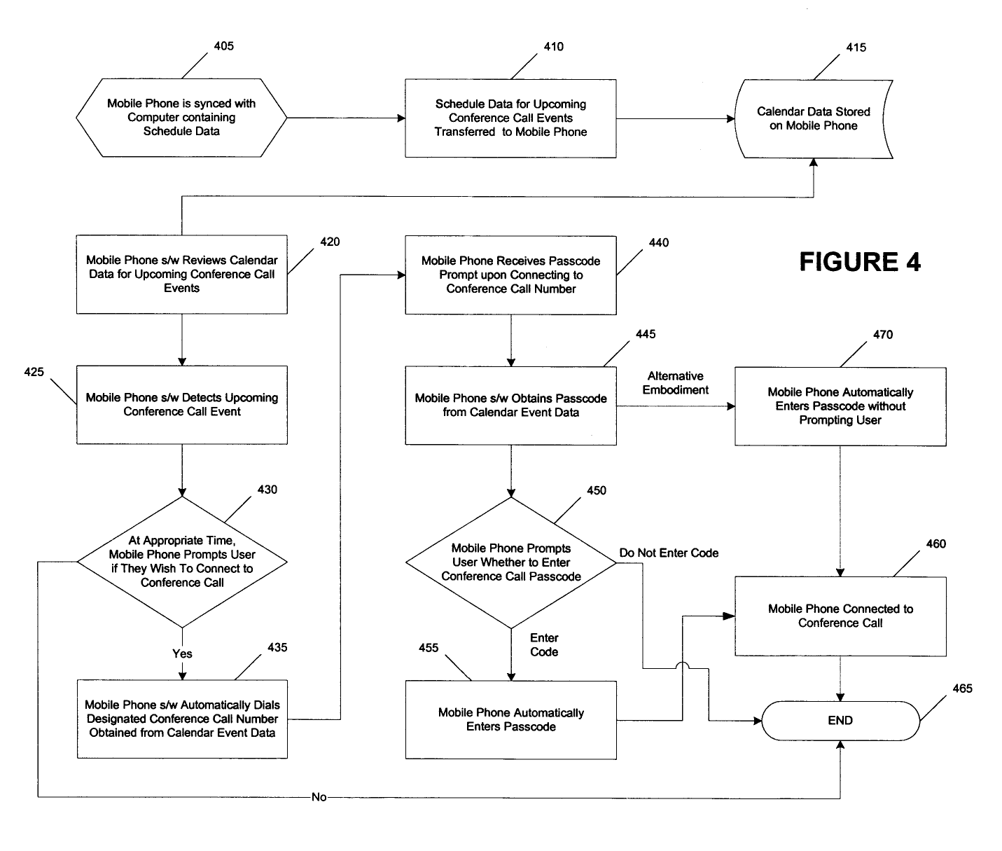

FIG. 4 is a flowchart that further details the logic implemented by computer software responsible for carrying out the concepts of the present invention. Initially, the mobile phone is ‘synced’ with a computing device that contains the user's contact and schedule data. Such information is contained in programs such as Microsoft Outlook or other organizational software that run's on the user's personal computer (PC). The syncing procedure is outside the scope of the present invention. It merely provides a mechanism for populating the mobile phone's own contact and scheduling program. The user may also input contact or schedule data directly into the mobile phone. Either way the data and procedures labeled as 405, 410, and 415 in FIG. 4 merely serve to populate the mobile phone's internal scheduling database and program.

The present invention begins by scanning the schedule database for conference call events 420. When a conference call is detected 425 the user is alerted at an appropriate time 430 by a pop-up dialog box that prompts the user whether he wishes to connect to the conference call. If the user responds affirmatively, the mobile phone will automatically dial the designated number 435 for the conference call that was included in the event data. Otherwise, if the user decides not to participate, the process is terminated 465. Once the mobile phone dials and connects to the designated conference call number, the mobile phone will typically receive a request for a passcode 440. The mobile phone then retrieves the passcode from the event data 445. The mobile phone then displays another pop-up dialog box that prompts the user whether he wishes to automatically enter the passcode 450. If the user responds affirmatively, the mobile phone will automatically enter the passcode 455 and the become connected to the conference call 460. If the user opts not to enter the passcode, the process is terminated 465.

In an alternative embodiment, the step of prompting the user for the passcode can be eliminated. Since the user has already expressed a desire to participate in the conference call, it may be deemed unnecessary to prompt whether to enter the passcode. Thus, when the mobile phone receives a request for a passcode 440 and obtains the passcode from the event data 445, the mobile can then automatically enter the passcode without having to prompt the user 470.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. A method of automatic initiation for connecting a mobile phone to a conference call, the method comprising:
in the mobile phone:
reviewing calendar event data stored in the mobile phone, the calendar event data containing conference call event data that includes a starting time for the conference call, a telephone number for the conference call, and a passcode authorizing connection to the conference call;
automatically producing an alert shortly before the starting time of the conference call;
displaying a prompt asking whether to connect to the conference call;
automatically dialing the telephone number for the conference call upon an affirmative response to the prompt asking whether to connect to the conference call;
receiving a prompt for the passcode authorizing connection to the conference call;
obtaining the passcode from the conference call event data; and
automatically entering the passcode.

2. The method of claim 1 wherein the affirmative response to the prompt asking whether to connect to the conference call is in the form of a keypress on the mobile phone keypad.

3. The method of claim 1 wherein the affirmative response to the prompt asking whether to connect to the conference call is in the form of a keyword voice response that is recognized by the mobile phone in a voice activated mode.

4. A system for automatic initiation for connecting a mobile phone to a conference call, the system comprising:
in the mobile phone:
means for reviewing calendar event data stored in the mobile phone, the calendar event data containing conference call event data that includes a starting time for the conference call, a telephone number for the conference call, and a passcode authorizing connection to the conference call;
means for automatically producing an alert shortly before the starting time of the conference call;
means for displaying a prompt asking whether to connect to the conference call;
means for automatically dialing the telephone number for the conference call upon an affirmative response to the prompt asking whether to connect to the conference call;
means for receiving a prompt for the passcode authorizing connection to the conference call;
means for obtaining the passcode from the conference call event data; and
means for automatically entering the passcode.

5. The system of claim 4 wherein the affirmative response to the prompt asking whether to connect to the conference call is in the form of a keypress on the mobile phone keypad.

6. The system of claim 4 wherein the affirmative response to the prompt asking whether to connect to the conference call is in the form of a keyword voice response that is recognized by the mobile phone in a voice activated mode.

7. A computer program product for automatic initiation for connecting a mobile phone to a conference call, the computer program product comprising:
in the mobile phone:
computer program code for reviewing calendar event data stored in the mobile phone, the calendar event data containing conference call event data that includes a starting time for the conference call, a telephone number for the conference call, and a passcode authorizing connection to the conference call;
computer program code for automatically producing an alert shortly before the starting time of the conference call;
computer program code for displaying a prompt asking whether to connect to the conference call;
computer program code for automatically dialing the telephone number for the conference call upon an affirmative response to the prompt asking whether to connect to the conference call;
computer program code for identifying a received prompt for the passcode authorizing connection to the conference call;
computer program code for obtaining the passcode from the conference call event data; and
computer program code for automatically entering the passcode.

8. The computer program product of claim 7 wherein the affirmative response to the prompt asking whether to connect to the conference call is in the form of a keypress on the mobile phone keypad.

9. The computer program product of claim 7 wherein the affirmative response to the prompt asking whether to connect to the conference call is in the form of a keyword voice response that is recognized by the mobile phone in a voice activated mode.
